(19) United States
(12) Patent Application Publication
(10) Pub. No.: US 2026/0335852 A1
(43) Pub. Date: Oct. 29, 2026

(54) CATALYST LOADING HOSE

(71) Applicant: Chevron U.S.A. Inc., San Ramon, CA (US)

(72) Inventors: Michelle Ashley Abrego, Berkeley, CA (US); Zial M. Maughan, Salt Lake City, UT (US); Michael Parish Jones, Moss Point, MS (US); John Martin Burnett, Richmond, CA (US)

(21) Appl. No.: 19/658,873

(22) Filed: Apr. 27, 2026

Related U.S. Application Data
(60) Provisional application No. 63/796,715, filed on Apr. 29, 2025.

(51) Int. Cl. B01J 8/00; F16L 11/08; F16L 11/12

(52) U.S. Cl. CPC B01J 8/003; F16L 11/085; F16L 11/122; B01J 2208/00752

(57) ABSTRACT

A catalyst loading hose may include a body that is substantially tubular in shape. The body has multiple layers, where each layer is flexible. A first layer forms an outer surface of the body, and a second layer forms an inner surface of the body. The first layer is configured to be durable when exposed to an ambient environment in which a hydroprocessing reactor is located. The second layer is configured to be durable when exposed to physical contact with a catalyst used by the hydroprocessing reactor. The top end of the body is configured to be disposed around the base of the catalyst loading hopper while the catalyst passes through the second layer of the body through the bottom end to the hydroprocessing reactor.

### CROSS-REFERENCE TO RELATED APPLICATIONS

This application claims priority to U.S. Provisional Patent Application Ser. No. 63/796,715 titled “Catalyst Loading Hose” and filed on Apr. 29, 2025, the entire contents of which are hereby incorporated herein by reference.

### TECHNICAL FIELD

The present application is related to methods, systems, and devices for transferring catalyst to a reactor.

### BACKGROUND

Typically, a rigid aluminum pipe is used to transfer catalyst into a hydroprocessing reactor. However, hard pipes can be difficult to assemble and more cumbersome to remove once the loading operation begins. The entrant is supplied breathing air when inside the reactor and must remove sections of pipe from the bottom. These sections then must be lifted past the in-place pipe and out of the reactor. Due to small interbed-manway sizes and congestion with other required work equipment, emergency access and egress from the reactor can be constrained with the hard pipe in place. Accordingly, using hard pipe is a time-consuming task.

In the alternative, a loading hose made from a flexible, soft sock-type material is sometimes used in the industry to transfer catalyst to save time. However, conventional flexible loading hoses typically lack features for drop prevention, and have unknown weight ratings, tear resistance, and/or strength, which can potentially lead to safety issues, and financial impact due to stopped or slowed operations.

Therefore, there is a need for an improved catalyst loading hose, and associated systems and methods, that can safely and efficiently be utilized for transferring catalyst to a reactor.

### SUMMARY

In general, in one aspect, the disclosure relates to a catalyst loading hose that includes a body having a top end and a bottom end, wherein the body is substantially tubular in shape, where the body includes a plurality of layers, where each layer of the plurality of layers is flexible, where the plurality of layers includes a first layer and a second layer, where the first layer forms an outer surface of the body, where the second layer forms an inner surface of the body, where the first layer is configured to be durable when exposed to an ambient environment in which a hydroprocessing reactor is located, where the second layer is configured to be durable when exposed to physical contact with a catalyst used by the hydroprocessing reactor, where the second layer has an inner perimeter that is at least as large as an outer perimeter of a base of a catalyst loading hopper, and where the top end of the body is configured to be disposed around the base of the catalyst loading hopper while the catalyst passes through the second layer of the body through the bottom end to the hydroprocessing reactor.

In another aspect, the disclosure relates to a catalyst system that includes a hydroprocessing reactor that uses a catalyst. The catalyst system may also include a catalyst loading hopper that provides the catalyst, wherein the catalyst loading hopper comprises a base. The catalyst system may further include a catalyst loading hose that facilitates a transfer of the catalyst from the base of the catalyst loading hopper to the hydroprocessing reactor, where the catalyst loading hose includes a body having a top end and a bottom end, where the body is substantially tubular in shape, wherein the body includes a plurality of layers, where each layer of the plurality of layers is flexible, where the plurality of layers includes a first layer and a second layer, where the first layer forms an outer surface of the body, where the second layer forms an inner surface of the body, where the first layer is configured to be durable when exposed to an ambient environment in which the hydroprocessing reactor and the catalyst loading hopper are located, where the second layer is configured to be durable when exposed to physical contact with the catalyst, where the second layer has an inner perimeter that is at least as large as an outer perimeter of the base of the catalyst loading hopper, and where the top end of the body is disposed around the base of the catalyst loading hopper while the catalyst passes through the second layer of the body through the bottom end to the hydroprocessing reactor.

These and other aspects, objects, features, and embodiments will be apparent from the following description and the appended claims.

### BRIEF DESCRIPTION OF THE DRAWINGS

The drawings illustrate only example embodiments of methods, systems, and devices for transferring catalyst to a reactor, and are therefore not to be considered limiting of its scope. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIG. 1 illustrates a block diagram of a catalyst system according to certain example embodiments.

FIG. 2 illustrates a top view of a catalyst loading hose according to certain example embodiments.

FIGS. 3A and 3B illustrate a front view and a top view, respectively, of an exemplary embodiment of a catalyst loading hose of the present invention.

FIGS. 4A and 4B illustrate a front view and a top view, respectively, of another exemplary embodiment of a catalyst loading hose of the present invention.

FIGS. 5A and 5B illustrate a front view and a sectional top view, respectively, of an exemplary embodiment of part of a system.

### DETAILED DESCRIPTION

The example embodiments discussed herein are directed to methods, systems, and flexible loading hoses for transferring catalyst to a reactor, whereby the loading hose includes a plurality of stabilizing restraints for positioning the hose in a relatively vertical position. In certain example embodiments, the systems and methods described herein can be subject to meeting certain standards and/or requirements, for example, withstanding required design loads for catalyst loading.

The use of the terms “about”, “approximately”, and similar terms applies to all numeric values, whether or not explicitly indicated. These terms generally refer to a range of numbers that one of ordinary skill in the art would consider as a reasonable amount of deviation to the recited numeric values (i.e., having the equivalent function or result). For example, this term may be construed as including a deviation of ±10 percent of the given numeric value provided such a deviation does not alter the end function or result of the value. Therefore, a value of about 1% may be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

Example embodiments of catalyst loading hoses (including components (e.g., layers) thereof) described herein can be made from a single piece (e.g., as from a mold, injection mold, casting, die cast, forging, extrusion process, or 3D printing). In addition, or in the alternative, example embodiments of catalyst loading hoses and systems can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, snap fittings, and slotted fittings. One or more pieces that are mechanically coupled to each other can be coupled to each other in one or more of a number of ways, including but not limited to fixedly, hingedly, removably, slidably, and threadably.

Components and/or features described herein can include elements that are described as coupling, fastening, securing, abutting against, in communication with, or other similar terms. Such terms are merely meant to distinguish various elements and/or features within a component or device and are not meant to limit the capability or function of that particular element and/or feature. For example, a feature described as a “coupling feature” can couple, secure, fasten, abut against, and/or perform other functions aside from merely coupling.

A coupling feature (including a complementary coupling feature) as described herein can allow one or more components and/or portions of an example catalyst loading hose to become coupled, directly or indirectly, to one or more other components of the catalyst loading hose and/or to some other component of a related system. A coupling feature can include, but is not limited to, a clamp, a portion of a hinge, an aperture, a recessed area, a protrusion, a hole, a slot, a tab, a detent, and mating threads. One portion of an example catalyst loading hose can be coupled to another component of the example catalyst loading hose and/or to some other component of a related system by the direct use of one or more coupling features.

In addition, or in the alternative, a portion of an example catalyst loading hose can be coupled to another component of the example catalyst loading hose and/or to another component of a related system using one or more independent devices that interact with one or more coupling features disposed on a component of the example catalyst loading hose. Examples of such devices can include, but are not limited to, a pin, a hinge, a fastening device (e.g., a bolt, a screw, a rivet), epoxy, glue, adhesive, and a spring. One coupling feature described herein can be the same as, or different than, one or more other coupling features described herein. A complementary coupling feature as described herein can be a coupling feature that mechanically couples, directly or indirectly, with another coupling feature.

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of catalyst loading hoses and systems will be described more fully hereinafter with reference to the accompanying drawings, in which example embodiments of catalyst loading hoses and systems are shown. Catalyst loading hoses and systems may, however, be embodied in many different forms and should not be construed as limited to the example embodiments set forth herein. Rather, these example embodiments are provided so that this disclosure will be thorough and complete, and will fully convey the scope of catalyst loading hoses and systems to those of ordinary skill in the art. Like, but not necessarily the same, elements (also sometimes called components) in the various figures are denoted by like reference numerals for consistency.

Terms such as “first”, “second”, “primary,” “secondary,” “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. Such terms are not meant to denote a preference or a particular orientation, and such terms are not meant to limit embodiments of catalyst loading hoses and systems. In the following description of the example embodiments, specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

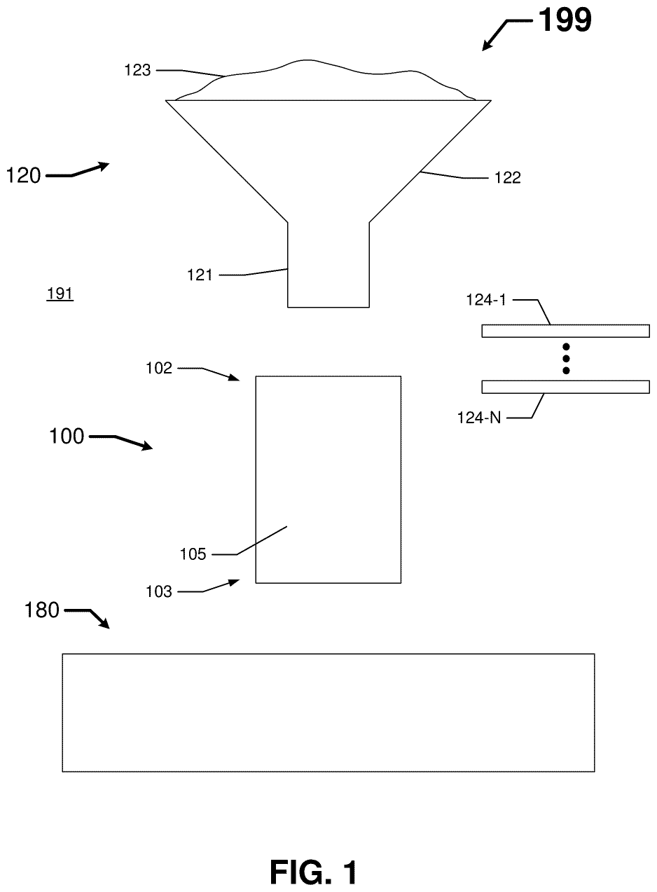

FIG. 1 illustrates a block diagram of a catalyst system 199 according to certain example embodiments. The catalyst system 199 of FIG. 1 includes a catalyst loading hopper 120, a hydroprocessing reactor 180, an example catalyst loading hose 100, and one or more securing devices 124. All of this equipment is located in an ambient environment 191 (e.g., an indoor facility, outdoors). The catalyst loading hopper 120 includes a base 121 and a body 122. A catalyst 123 of located inside the body 122 of the catalyst loading hopper 120 and exits through the base 121 to be conveyed through the example catalyst loading hose 100 to the hydroprocessing reactor 180, which uses the catalyst 123 as part of a hydroprocessing reaction performed therein. The hydroprocessing reactor 180 has a number of different characteristics (e.g., shape, size, materials) and configurations that may be used with the example catalyst loading hose 100.

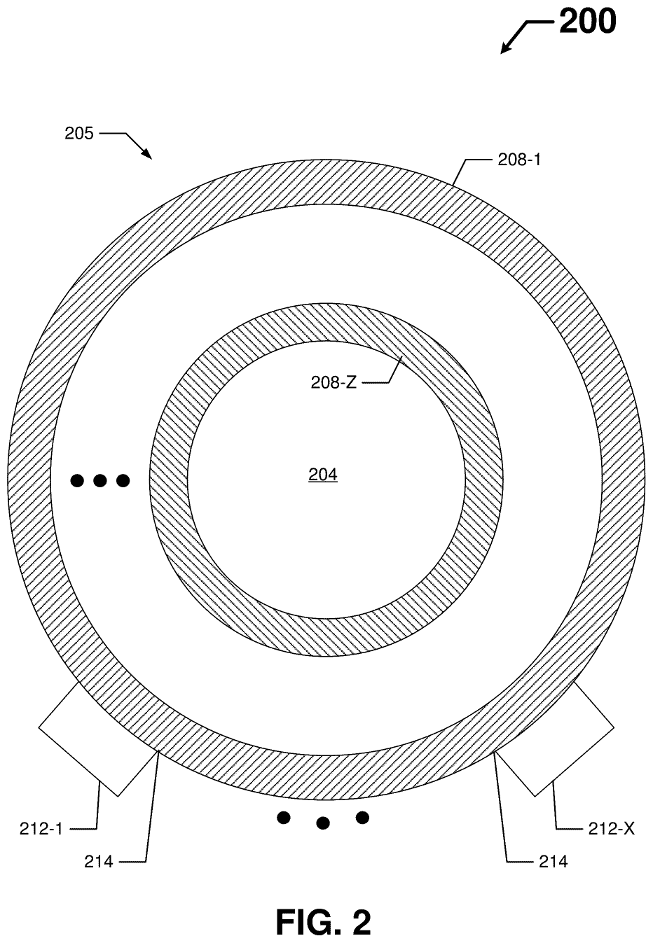

The example catalyst loading hose 100 has a substantially tubular shape that is formed by a body 105 with a top end 102 (e.g., a first end, a second end) and a bottom end 103 (e.g., a second end, a first end). The distance between the top end 102 and the bottom end 103 represents the length (e.g., 5 feet, 10 feet, 25 feet, 50 feet, 100 feet, 250 feet) of the body 105. The top end 102 of the body 105 is configured to be disposed around the base 121 of the catalyst loading hopper 120 while the catalyst 123 passes through the body 105 of the catalyst loading hose 100 through the bottom end 103 of the catalyst loading hose 100 to the hydroprocessing reactor 180. More details about the example catalyst loading hose (e.g., catalyst loading hose 100) are discussed below with respect to FIG. 2.

The catalyst system 199 can include a number (e.g. 1, 2, 3, 5) of securing devices 124. In this case, the catalyst system 199 includes N securing devices 124 (securing device 124-1 through securing device 124-N). A securing device 124 is configured to be positioned over the outer perimeter of the top end 102 of the body 105. In this way, a securing device 124 is configured to secure the top end 102 of the body 105 against the base 121 of the catalyst hopper 120. A securing device 124 may have a number of different configurations (e.g., shape, size, material). For example, a securing device 124 may be in the form of a clamp made of metal.

FIG. 2 illustrates a top view of a catalyst loading hose 200 according to certain example embodiments. Referring to the description above with respect to FIG. 1, the catalyst loading hose 200 of FIG. 2 is substantially the same as the catalyst loading hose 100 of FIG. 1. In this case, the catalyst loading hose 200 has a body 205 with multiple layers 208 and one or more optional restraint tabs 212. Each layer 208 of the body 205 is flexible, and so the body 205 of the catalyst loading hose 200 is flexible. The number (e.g., 2, 3, 4, 5, 6, 10) of layers 208 of the body 205 may vary. In this example, the body 205 had Z layers 208 (layer 208-1 through layer 208-Z). The configuration (e.g., thickness, material, amount of flexibility) of one layer 208 of the body 205 may be the same as, or different than, the configuration of one or more of the other layers 208 of the body 205. A layer 208 may have any thickness (e.g., a couple of mils, a centimeter, an inch, two inches). For example, a layer 208 may be a coating that is 2-4 mils thick. As another example, a layer 208 may be an extruded mesh that is two centimeters thick.

In this example, layer 208-1 of the body 205 is the outer-most layer, and so the outer surface of the layer 208-1 forms the outer surface of the body 205. In this way, layer 208-1 is configured to be durable when exposed to an ambient environment (e.g., ambient environment 191) in which a hydroprocessing reactor (e.g., hydroprocessing reactor 180) is located. In addition, layer 208-Z of the body 205 is the inner-most layer, and so the inner surface of the layer 208-Z forms the inner surface of the body 205. In this way, layer 208-Z is configured to be durable when exposed to physical contact with a catalyst (e.g., catalyst 123) used by the hydroprocessing reactor (e.g., hydroprocessing reactor 180). Also, layer 208-Z has an inner perimeter that is at least as large as the outer perimeter of a base (e.g., base 121) of a catalyst loading hopper (e.g., catalyst loading hopper 120). The inner surface of the inner layer 208-Z of the body 205 forms a cavity 204 through which catalyst (e.g., catalyst 123) is transmitted.

Adjacent layers 208 of the body 205 may be coupled to each other in one or more of a number of ways. For example, two or more layers 208 of a body 205 may be fused together. As another example, two or more layers 208 of a body 205 may be glued together. As another example, two or more layers 208 of a body 205 may be held together by rivets, bolts, and/or other types of fastening devices. As another example, two or more layers 208 of a body 205 may be held together by a bracket at the top end (e.g., the top end 102) and/or at the bottom end (e.g., bottom end 103) of the body 205. Layers 208 of the body 205 may be coupled together at one or more points (e.g., toward the top end of the body 205, toward the bottom end of the body 205, along the length of the body 205).

Each restraint tab 212 is configured to secure, directly or indirectly, the body 205 in position relative to the base (e.g., base 121) of a catalyst hopper (e.g., catalyst hopper 120) and/or to a hydroprocessing reactor (e.g., hydroprocessing reactor 180). Each restraint tab 212 may have any of a number of configurations. For example, a restraint tab 212 may be coupled to the outer layer 208-1 of the body 205 using one or more coupling features 214 (e.g., sutures, seals, bolts, welds). As another example, a restraint tab 212 may be integrated with the outer layer 208-1 of the body 205.

As discussed above, a restraint tab 212 may directly or indirectly secure the body 205 of the catalyst loading hose 200 in position relative to the base (e.g., base 121) of a catalyst hopper and/or to a hydroprocessing reactor. For example, a restraint tab 212 may be in the form of a closed loop where each end of the closed loop is coupled to and/or integrated with the outer layer 208-1 of the body 205. In such a case, the restraint tab 212 is configured to receive a strap that is tied to a feature (e.g., one or more reactor head studs, one or more components internal to the hydroprocessing reactor) exposed to the ambient environment (e.g., ambient environment 191) and/or within the hydroprocessing reactor. As another example, a restraint tab 212 may be in the form of a pair of straps where an end of each strap is coupled to and/or integrated with the outer layer 208-1 of the body 205. In such a case, the opposite end of each strap is configured to be tied to each other around a feature exposed to the ambient environment and/or within the hydroprocessing reactor.

The body 205 of the catalyst loading hose 200 may have no restraint tabs 212 or a number (e.g., 1, 2, 4, 8, 10, 15, 20) of restraint tabs 212. When the body 205 has multiple restraint tabs 212, the configuration (e.g., shape, size, material composition, degree of flexibility, coupling features) of one restraint tab 212 may be the same as, or different than, the configuration of one or more of the other restraint tabs 212. In some cases, a restraint tab 212 is flexible. In some cases, a restraint tab has a composition that matches that of the outer layer 208-1 of the body 205. In addition, or in the alternative, when the body 205 has multiple restraint tabs 212, some or all of the restraint tabs 212 may be substantially evenly distributed around the outer perimeter of the outer layer 208-1 of the body 205.

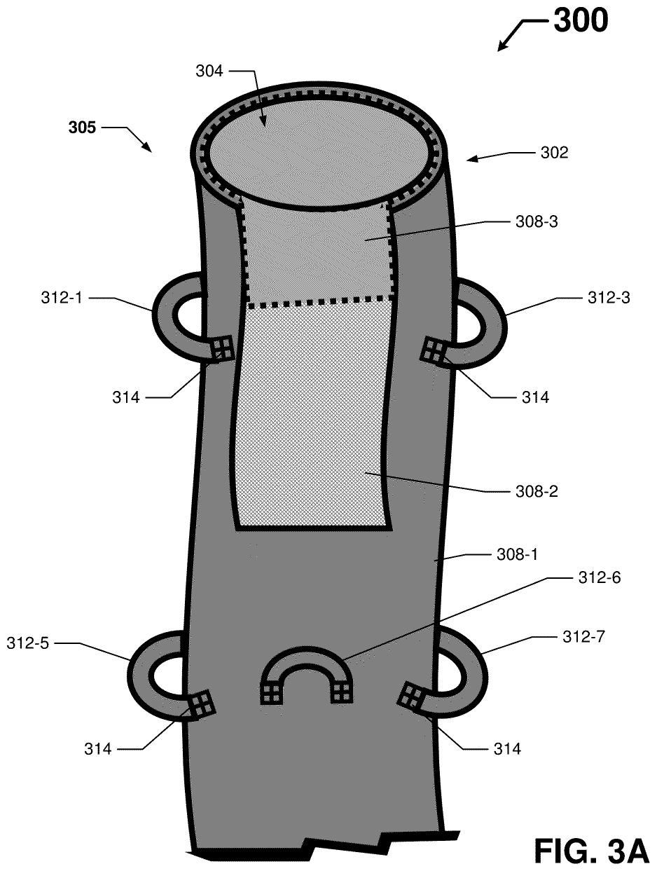

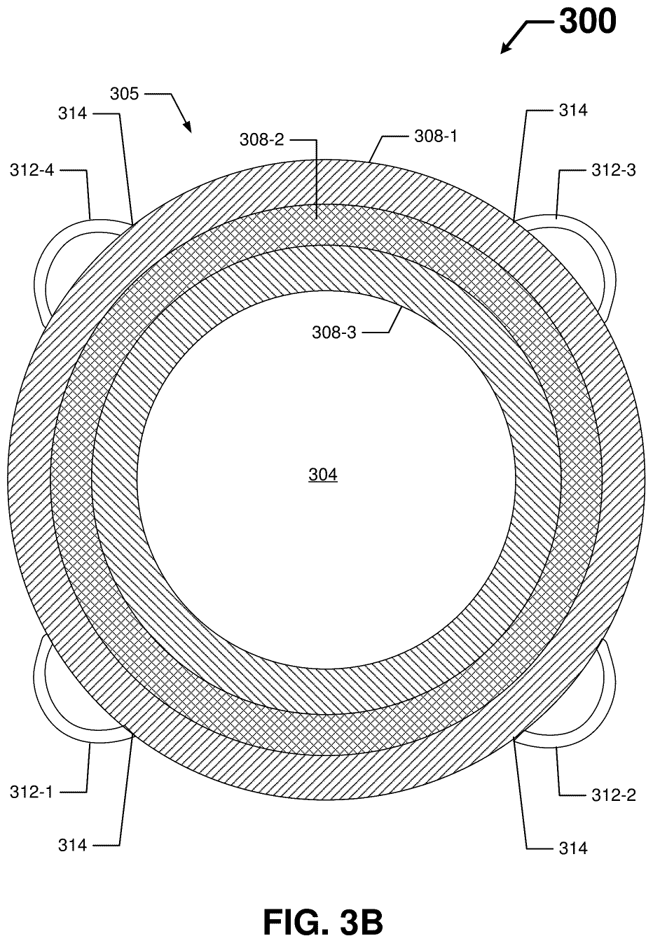

FIGS. 3A and 3B illustrate a front view and a top view, respectively, of an exemplary embodiment of a catalyst loading hose 300. Referring to the description above with respect to FIGS. 1 and 2, the front view of the catalyst loading hose 300 of FIG. 3A includes a cut away of the three layers 308 of the body 305 of the catalyst loading hose 300. The body 305 of the catalyst loading hose 300 has a top (e.g., first) end 302 and a bottom (e.g., second) end (not shown), and a cavity 304 extending from the top end 302 to the bottom end. The top end 302 of the body 305 of the catalyst loading hose 300 is configured to couple to a base (e.g., base 121) of a catalyst loading hopper (e.g., catalyst loading hopper 120). The body 305 of the catalyst loading hose 300 of FIGS. 3A and 3B is constructed of an inner layer 308-3, a middle layer 308-2, and an outer layer 308-1. Each of the layers 308 of the body 305 is flexible (not rigid), and so the body 305 is flexible.

Each layer 308 of the body 305 may have a number of different characteristics (e.g., thickness, material). For example, in certain embodiments, the inner layer 308-3 and/or the outer layer 308-1 are constructed from polyvinyl chloride (PVC). As another example, the inner layer 308-3 and/or outer layer 308-1 may be constructed from a blend of PVC and nitrile rubber. As another example, the middle layer 308-2 may be constructed from a flexible, durable synthetic fabric. In such cases, the synthetic fabric is a synthetic woven mesh. As another example, the inner layer 308-3, middle layer 308-2, and outer layer 308-1 may be constructed from a textile weave fabric, such as three-ply polyester yarns, via extrusion.

In certain exemplary embodiments, each layer 308 of the body 305 of the catalyst loading hose 300 is constructed from a material that is abrasion resistant and that can withstand temperatures up to approximately 100 degrees Fahrenheit. In certain exemplary embodiments, the inner layer 308-3 of the body 305 of the catalyst loading hose 300 has an inner diameter that ranges from about 4 inches to about 8 inches. In some cases, the outer layer 308-1 of the body 305 of the catalyst loading hose 300 has an outer diameter that ranges from about 5 inches to about 10 inches. The body 305 may have a thickness that ranges from about 0.25 inches to about 3 inches.

The catalyst loading hose 300 also includes a plurality of restraint tabs 312 for securing the catalyst loading hose 300 to reactor head studs within the ambient environment (e.g., ambient environment 191) and/or components internal to a hydroprocessing reactor (e.g., hydroprocessing reactor 180). In this example, the restraint tabs 312 are in the form of loops that are coupled to the outer surface of the outer layer 308-1 of the body 305 using coupling features 314. In this way, straps and/or other similar implements may be inserted through each restraint tab 312 and tied off to equipment and/or features in the ambient environment and/or within a hydroprocessing reactor using straps.

In certain example embodiments, a number (e.g., 2, 3, 4, 5, 6, 8) of the restraint tabs 312 may be spaced along the same plane (e.g., a horizontal plane) along a circular cross-section of the catalyst loading hose 300. In such a case, the restraint tabs 312 in a row may be spaced equidistantly with respect to each other around the outer perimeter of the outer layer 308-1 of the body 305. In some cases, there may be a single row of restraint tabs 312 or multiple (e.g., 2, 3, 4, 5, 6) rows of restraint tabs 312. When there are multiple rows of restraint tabs 312, the number of restraint tabs 312 in one row may be the same as, or different than, the number of restraint tabs 312 in one or more of the other rows.

In this case, there are a total of 8 restraint tabs 312, where only restraint tab 312-1, restraint tab 312-2, restraint tab 312-3, restraint tab 312-5, restraint tab 312-6, and restraint tab 312-7 are visible in the views provided in FIGS. 3A and 3B. The restraint tabs 312 are arranged in 2 rows of 4 on the body 305. In each row, the 4 restraint tabs 312, are spaced substantially equidistantly from each other along the outer perimeter of the outer layer 308-1 of the body 305. For example, as shown in FIG. 3B, restraint tab 312-1, restraint tab 312-2, restraint tab 312-3, and restraint tab 312-4 are spaced substantially equidistantly along the same plane along the circular cross-section of the catalyst loading hose 300. The two rows of restraint tabs 312 in this case may be spaced some distance (e.g., 5 feet, 10 feet, 20 feet, 50 feet) apart along the length of the catalyst loading hose 300.

One having ordinary skill in the art will recognize that any number of restraint tabs 312 may be included on the catalyst loading hose 300 to help support the weight of the catalyst loading hose 300 and/or maintain the position of the catalyst loading hose 300 while catalyst (e.g., catalyst 123) passes through the cavity 304. One having ordinary skill in the art will also recognize that the restraint tabs 312 may be positioned about the perimeter and along the length of the outer layer 308-1 of the body 305 in a number of different configurations.

In exemplary embodiments, the restraint tabs 312 are secured to the perimeter of the outer layer 308-1 of the body 305 by coupling features 314 in the form of sutures. In certain embodiments, the middle layer 308-2 may be extruded with a PVC coating as the outer layer 308-1, after which the restraint tabs 312 may be stitched to the outer layer 308-1 of the body 305 of the catalyst loading hose 300, and then coated separately.

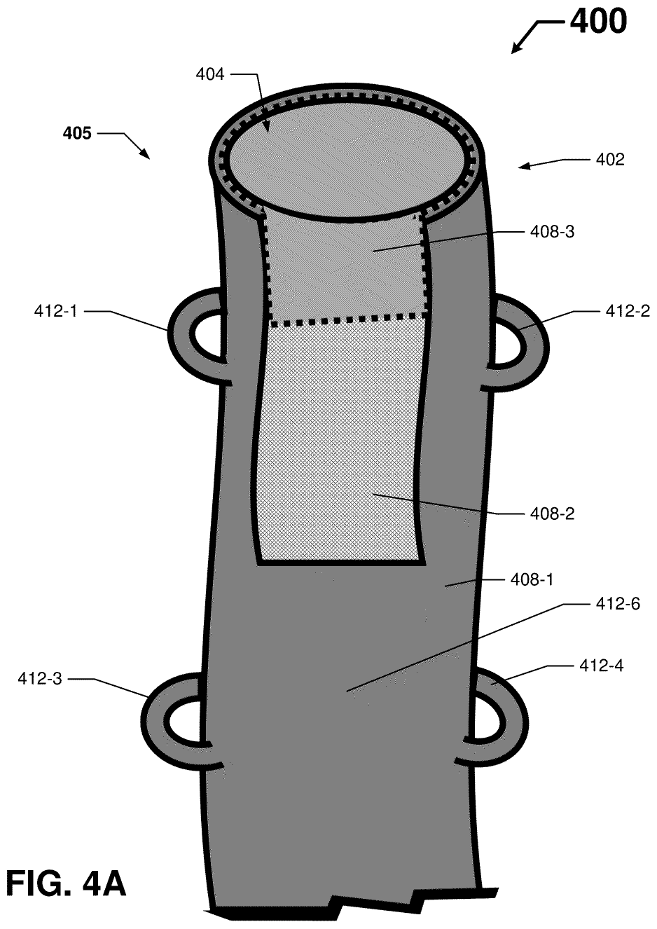

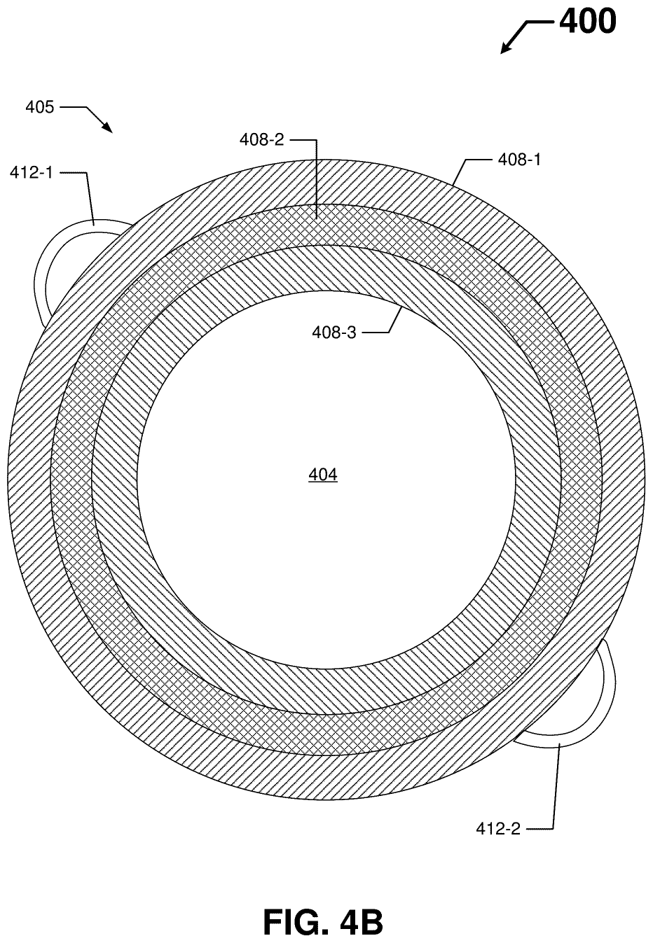

FIGS. 4A and 4B illustrate a side view and a top view, respectively, of another exemplary embodiment of a catalyst loading hose 400. Referring to the description above with respect to FIGS. 1 through 3B, the catalyst loading hose 400 of FIGS. 4A and 4B is substantially similar to catalyst loading hoses of FIGS. 1 through 3B, except as described below. For example, the body 405 of the catalyst loading hose 400 has a top (e.g., first) end 402 and a bottom (e.g., second) end (not shown), and a cavity 404 extending from the top end 402 to the bottom end. The top end 402 of the body 405 of the catalyst loading hose 400 is configured to couple to a base (e.g., base 121) of a catalyst loading hopper (e.g., catalyst loading hopper 120). The body 405 of the catalyst loading hose 400 of FIGS. 4A and 4B is constructed of an inner layer 408-3, a middle layer 408-2, and an outer layer 408-1. Each of the layers 408 of the body 405 is flexible (not rigid), and so the body 405 is flexible.

Each layer 408 of the body 405 may have a number of different characteristics (e.g., thickness, material). For example, in certain embodiments, the inner layer 408-3 and/or the outer layer 408-1 are constructed from polyvinyl chloride (PVC). As another example, the inner layer 408-3 and/or outer layer 408-1 may be constructed from a blend of PVC and nitrile rubber. As another example, the middle layer 408-2 may be constructed from a flexible, durable synthetic fabric. In such cases, the synthetic fabric is a synthetic woven mesh. As another example, the inner layer 408-3, middle layer 408-2, and outer layer 408-1 may be constructed from a textile weave fabric, such as three-ply polyester yarns, via extrusion.

In certain exemplary embodiments, each layer 408 of the body 405 of the catalyst loading hose 400 is constructed from a material that is abrasion resistant and that can withstand temperatures up to approximately 100 degrees Fahrenheit. In certain exemplary embodiments, the inner layer 408-3 of the body 405 of the catalyst loading hose 400 has an inner diameter that ranges from about 4 inches to about 8 inches. In some cases, the outer layer 408-1 of the body 405 of the catalyst loading hose 400 has an outer diameter that ranges from about 4 inches to about 10 inches. The body 405 may have a thickness that ranges from about 0.25 inches to about 1 inch.

The catalyst loading hose 400 of FIGS. 4A and 4B includes a plurality of restraint tabs 412 for securing the catalyst loading hose 400 to reactor head studs within the ambient environment (e.g., ambient environment 191) and/or components internal to a hydroprocessing reactor (e.g., (e.g., hydroprocessing reactor 180)). In this example, the restraint tabs 412 are in the form of loops that are integral with the outer surface of the outer layer 408-1 of the body 405. With the configuration of the restraint tabs 412, straps and/or other similar implements may be inserted through each restraint tab 412 and tied off to equipment and/or features in the ambient environment and/or within a hydroprocessing reactor using straps.

In this case, there are a total of 4 restraint tabs 412 (restraint tab 412-1, restraint tab 412-2, restraint tab 412-3, and restraint tab 412-4) that extend from the outer surface of the outer layer 408-1 of the body 405. The restraint tabs 412 are arranged in 2 rows of 2 on the body 405. In each row, the 2 restraint tabs 412 are spaced substantially equidistantly from each other along the outer perimeter of the outer surface 408-1 of the body 405. For example, as shown in FIG. 4B, restraint tab 412-1 and restraint tab 412-2 are spaced opposite each other along the same plane along the circular cross-section of the catalyst loading hose 400. The two rows of restraint tabs 412 in this case may be spaced some distance (e.g., 5 feet, 10 feet, 25 feet, 50 feet) apart along the length of the catalyst loading hose 400.

As discussed above, in this case, rather than the restraint tabs 412 being coupled to the outer surface of the outer layer 408-1 of the body 405, the restraint tabs 412 are integral to and extend from the outer perimeter of the outer layer 408-1 of the body 405. The outer layer 408-1 having integral restraint tabs 412 on the body 405 of the catalyst loading hose 400 may be fabricated using any suitable process known to one having ordinary skill in the art. In some cases, one or more of the restraint tabs 412 may have multiple layers (e.g., similar to the layers 408 of the body 405). For example, in this case, the restraint tabs 412, like the middle layer 408-2, may be an extruded metal mesh with a PVC coating (e.g., 8 mils thick, 25 mils thick) as the outer layer of the restraint tabs 412.

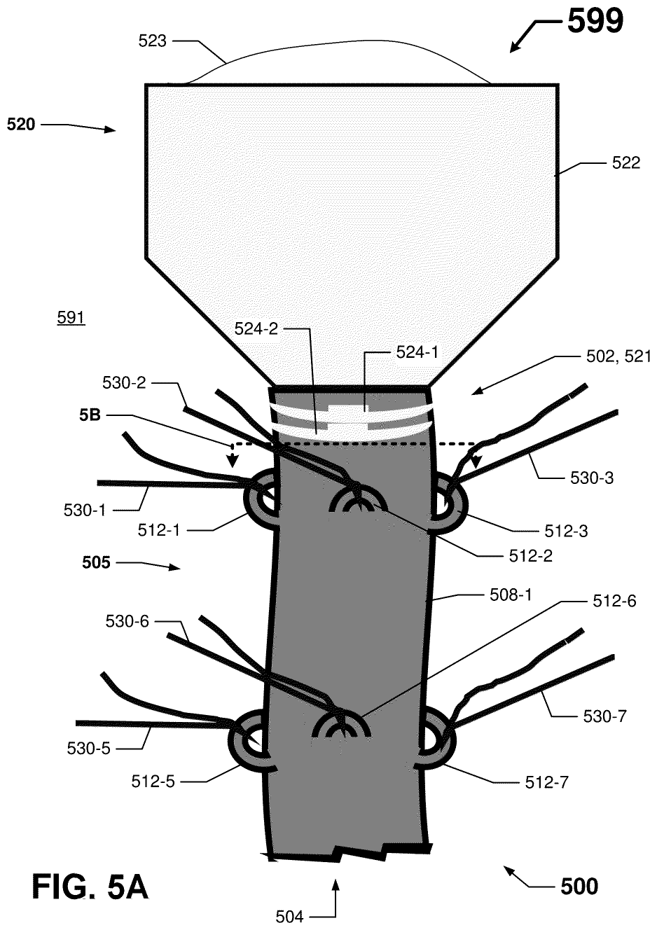

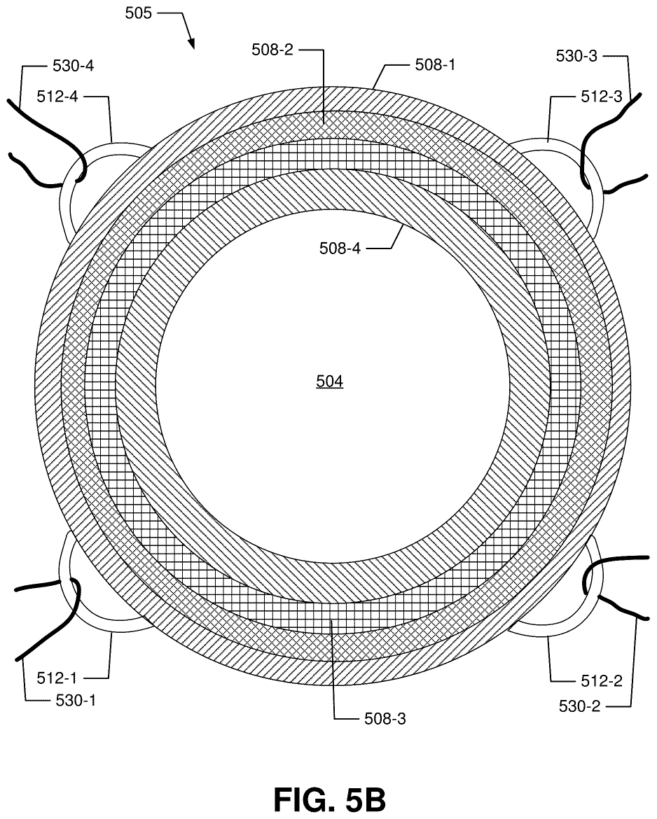

FIGS. 5A and 5B illustrate a front view and a sectional top view, respectively, of part of a system 599 of the present invention according to certain example embodiments. Referring to the description above with respect to FIGS. 1 through 4B, the system 599 of FIGS. 5A and 5B includes a catalyst loading hopper 520 and an example catalyst loading hose 500. The catalyst loading hopper 520 and the catalyst loading base 500 (including components thereof) may be substantially similar to the catalyst loading hopper and the catalyst loading bases (including corresponding components thereof) discussed above.

For example, the body 505 of the catalyst loading hose 500 has a top (e.g., first) end 502 and a bottom (e.g., second) end (not shown), and cavity (hidden from view, but similar to the cavity 404 discussed above) extending from the top end 502 to the bottom end. The catalyst 523, placed in the body 522 of the catalyst loading hopper 520, pours through the cavity along the length of the body 505 from the top end 502 to the bottom end. The top end 502 of the body 505 of the catalyst loading hose 500 is indirectly coupled to the base (hidden from view, but substantially similar to the base 121 of FIG. 1) of the catalyst loading hopper 520. The body 505 of the catalyst loading hose 500 of FIGS. 5A and 5B is constructed of four layers 508: An inner layer 508-4, a first middle layer 508-3, a second middle layer 508-2, and an outer layer 508-1. Each of the layers 508 of the body 505 is flexible (not rigid), and so the body 505 is flexible.

Each layer 508 of the body 505 may have a number of different characteristics (e.g., thickness, material). For example, in certain embodiments, the inner layer 508-4 and/or the outer layer 508-1 may be constructed from PVC. As another example, the inner layer 508-4 and/or outer layer 508-1 may be constructed from a blend of PVC and nitrile rubber. As another example, the first middle layer 508-3 may be constructed from a flexible, durable synthetic fabric (e.g., in the form of a synthetic woven mesh), and the second middle layer 508-3 may be a metal mesh jacket. As another example, one or more of the layers 508 may be constructed from a textile weave fabric, such as three-ply polyester yarns, via extrusion.

In certain exemplary embodiments, each layer 508 of the body 505 of the catalyst loading hose 500 may be constructed from a material that is abrasion resistant and that can withstand temperatures within the ambient environment 591 (e.g., up to approximately 100 degrees Celsius). In certain exemplary embodiments, the inner layer 508-4 of the body 505 of the catalyst loading hose 500 has an inner diameter that ranges from about 6 inches to about 8 inches. In some cases, the outer layer 508-1 of the body 505 of the catalyst loading hose 500 has an outer diameter that ranges from about 4 inches to about 10 inches. The body 505 may have a thickness that ranges from about 0.25 inches to about 1 inch.

The catalyst loading hose 500 of FIGS. 5A and 5B includes a plurality of restraint tabs 512 for securing the catalyst loading hose 500 to reactor head studs within the ambient environment 591 and/or components internal to a hydroprocessing reactor (e.g., hydroprocessing reactor 180). In this example, the restraint tabs 512 are in the form of loops that are integrated with the outer surface of the outer layer 508-1 of the body 505. With the configuration of the restraint tabs 512, straps 530 and/or other similar implements may be inserted through each restraint tab 512 and tied off to equipment and/or features in the ambient environment 591 and/or within a hydroprocessing reactor using straps. For example, as shown in FIGS. 5A and 5B, strap 530-1 is inserted through restraint tab 512-1, strap 530-2 is inserted through restraint tab 512-2, strap 530-3 is inserted through restraint tab 512-3, strap 530-4 is inserted through restraint tab 512-4, strap 530-5 is inserted through restraint tab 512-5, strap 530-6 is inserted through restraint tab 512-6, and strap 530-7 is inserted through restraint tab 512-7. The straps 530, in conjunction with the restraint tabs 512, help keep the body 53-0 of the catalyst loading hose 500 in a substantially vertical position while catalyst 523 is transferred from the catalyst loading hopper 520 to a hydroprocessing reactor (not shown, but substantially similar to the hydroprocessing reactor 180 of FIG. 1) through the cavity 504 of the body 505 of the catalyst loading hose 500. Examples of a strap 530 may include, but are not limited to, a synthetic sling, a nylon sling, a chain, a wire rope cable, a soft choker, and a crane rigging choker.

In this case, there are a total of 8 restraint tabs 512, where only restraint tab 512-1, restraint tab 512-2, restraint tab 512-3, restraint tab 512-4, restraint tab 512-5, restraint tab 512-6, and restraint tab 512-7 are visible in FIGS. 5A and 5B. Each restraint tab 512 extends from the outer surface of the outer layer 508-1 of the body 505. The restraint tabs 512 are arranged in 2 rows of 4 on the body 505. In each row, the 4 restraint tabs 512 are spaced substantially equidistantly from each other along the outer perimeter of the outer layer 508-1 of the body 505. For example, as shown in FIG. 5B, restraint tab 512-1, restraint tab 512-2, restraint tab 512-3, and restraint tab 512-4 are spaced substantially equidistantly from each other along the same plane along the circular cross-section of the catalyst loading hose 500. The two rows of restraint tabs 512 in this case may be spaced some distance (e.g., 5 feet, 10 feet, 25 feet, 50 feet) apart along the length of the catalyst loading hose 500.

As discussed above, in this case, rather than the restraint tabs 512 being coupled to the outer surface of the outer layer 508-1 of the body 505, the restraint tabs 512 are integral to and extend from the outer perimeter of the outer layer 508-1 of the body 505. The outer layer 508-1 having integral restraint tabs 512 on the body 505 of the catalyst loading hose 500 may be fabricated using any suitable process known to one having ordinary skill in the art. In some cases, one or more of the restraint tabs 512 may have multiple layers (e.g., similar to the layers 508 of the body 505). For example, in this case, the restraint tabs 512, like the second middle layer 508-2, may be an extruded metal mesh with a PVC coating (e.g., 8 mils thick, 1 centimeter thick) as the outer layer of the restraint tabs 512.

In this case, the example catalyst loading hose 500 is secured to the base 521 of the catalyst loading hopper 520 using one or more securing devices 524. In this case, there are two securing devices 524 (securing device 524-1 and securing device 524-2) that are both in the form of clamps. Securing device 524-1 is positioned above securing device 524-2. In this case, securing device 524-1 and securing device 524-2 secure (e.g., clamp) the top end 502 of the body 505 of the catalyst loading hose 500 against the outer surface of the base 521 of the catalyst loading hopper 520.

Methods of the present invention include positioning a catalyst loading hose of the present invention within a reactor and extending vertically upward, securing the top of the catalyst loading hose to the base of a catalyst loading hopper, further securing the catalyst loading hose in a generally vertical position using the restraint tabs and straps, and transferring catalyst from the catalyst loading hopper into the hydroprocessing reactor through the catalyst loading hose.

Example embodiments of the present invention may offer a safer and more efficient way to perform catalyst loading over conventional transfers utilizing rigid, or hard, pipes. The present invention can save time, and potentially reduce the downtime of process units. The catalyst loading hose of the present invention would allow an entrant to cut the catalyst loading hose as the loading process progresses, which would eliminate the removal of hard pipe associated with conventional processes. The flexibility of the catalyst loading hose of the present invention would also alleviate the emergency access and egress constraints currently posed by hard pipe.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A catalyst loading hose comprising:
a body having a top end and a bottom end, wherein the body is substantially tubular in shape, wherein the body comprises a plurality of layers, wherein each layer of the plurality of layers is flexible, wherein the plurality of layers comprises a first layer and a second layer, wherein the first layer forms an outer surface of the body, wherein the second layer forms an inner surface of the body, wherein the first layer is configured to be durable when exposed to an ambient environment in which a hydroprocessing reactor is located, wherein the second layer is configured to be durable when exposed to physical contact with a catalyst used by the hydroprocessing reactor, wherein the second layer has an inner perimeter that is at least as large as an outer perimeter of a base of a catalyst loading hopper, and wherein the top end of the body is configured to be disposed around the base of the catalyst loading hopper while the catalyst passes through the second layer of the body through the bottom end to the hydroprocessing reactor.

2. The catalyst loading hose of claim 1, wherein the first layer of the body comprises polyvinyl chloride (PVC).

3. The catalyst loading hose of claim 1, wherein the second layer of the body comprises polyvinyl chloride (PVC) and nitrile rubber.

4. The catalyst loading hose of claim 1, wherein the plurality of layers are coupled to each other toward the top end of the body.

5. The catalyst loading hose of claim 1, wherein the plurality of layers of the body further comprises a third layer positioned between the first layer and the second layer.

6. The catalyst loading hose of claim 5, wherein the third layer of the body comprises a synthetic woven mesh.

7. The catalyst loading hose of claim 1, wherein the first layer of the body further comprises a plurality of restraint tabs that are integrated with an outer surface of the first layer, wherein the plurality of restraint tabs extend outward from an outer surface of the first layer, and wherein each of the plurality of restraint tabs is configured to secure the body in position relative to the base of the catalyst hopper and to the hydroprocessing reactor.

8. The catalyst loading hose of claim 7, wherein each of the plurality of restraint tabs form a loop.

9. The catalyst loading hose of claim 7, wherein the plurality of restraint tabs is substantially evenly distributed around an outer perimeter of the first layer of the body.

10. The catalyst loading hose of claim 1, further comprising:
a plurality of restraint tabs that are coupled to an outer surface of the first layer, and wherein each of the plurality of restraint tabs is configured to secure the body in position relative to the base of the catalyst hopper and to the hydroprocessing reactor.

11. The catalyst loading hose of claim 10, wherein each of the plurality of restraint tabs is configured to receive a strap that is tied to a feature exposed to the ambient environment.

12. The catalyst loading hose of claim 10, wherein the each of the plurality of restraint tabs is flexible, and wherein each of the plurality of restraint tabs has a composition that matches that of the first layer of the body.

13. The catalyst loading hose of claim 1, further comprising:
a securing device that is configured to be positioned over an outer perimeter of the first layer toward the top end of the body, wherein the securing device is configured to secure the top end of the body against the base of the catalyst hopper.

14. The catalyst loading hose of claim 13, wherein the securing device comprises a clamp.

15. A catalyst system comprising:
a hydroprocessing reactor that uses a catalyst;
a catalyst loading hopper that provides the catalyst, wherein the catalyst loading hopper comprises a base; and
a catalyst loading hose that facilitates a transfer of the catalyst from the base of the catalyst loading hopper to the hydroprocessing reactor, wherein the catalyst loading hose comprises a body having a top end and a bottom end, wherein the body is substantially tubular in shape, wherein the body comprises a plurality of layers, wherein each layer of the plurality of layers is flexible, wherein the plurality of layers comprises a first layer and a second layer, wherein the first layer forms an outer surface of the body, wherein the second layer forms an inner surface of the body, wherein the first layer is configured to be durable when exposed to an ambient environment in which the hydroprocessing reactor and the catalyst loading hopper are located, wherein the second layer is configured to be durable when exposed to physical contact with the catalyst, wherein the second layer has an inner perimeter that is at least as large as an outer perimeter of the base of the catalyst loading hopper, and wherein the top end of the body is disposed around the base of the catalyst loading hopper while the catalyst passes through the second layer of the body through the bottom end to the hydroprocessing reactor.

16. The catalyst system of claim 15, wherein the plurality of layers of the body of the catalyst loading hose further comprises a third layer positioned between the first layer and the second layer, and wherein the third layer of the body of the catalyst loading hose comprises a synthetic woven mesh.

17. The catalyst system of claim 15, wherein the first layer and the second layer of the body of the catalyst loading hose comprise polyvinyl chloride (PVC).

18. The catalyst system of claim 15, wherein the catalyst loading hose further comprises a plurality of restraint tabs that extend outward from an outer surface of the first layer of the body, and wherein each of the plurality of restraint tabs is configured to secure the catalyst loading hose in position relative to the base of the catalyst hopper and to the hydroprocessing reactor.

19. The catalyst system of claim 18, further comprising:
a plurality of straps that engage the plurality of restraint tabs and a plurality of features exposed to the ambient environment.

20. The catalyst system of claim 15, wherein the catalyst loading hose further comprises a securing device disposed over the top end of the body of the catalyst loading hose to secure the top end of the body of the catalyst loading hose against the base of the catalyst hopper.
